(19) United States
(12) Patent Application Publication
(10) Pub. No.: US 2007/0108677 A1
(43) Pub. Date: May 17, 2007

(54) HYDRAULIC BEARING AND PROCESS FOR MANUFACTURING A HYDRAULIC BEARING

(76) Inventors: Toralf HUETTNER, Osnabrueck (DE); Hubert Siemer, Dinklage (DE); Stefan Loheide, Wallenhorst (DE); Thomas Mechelhoff, Dinklage (DE); Reimund Boergerding, Steinfeld (DE)

Correspondence Address: MCGLEW & TUTTLE, PC, P.O. BOX 9227, SCARBOROUGH STATION, SCARBOROUGH, NY, 10510-9227, US

(21) Appl. No.: 11/556,841

(22) Filed: Nov. 6, 2006

(30) Foreign Application Priority Data
Nov. 15, 2005 (DE) 10 2005 054 852.0

(51) Int. Cl. F16F 9/00

(52) U.S. Cl. 267/140.11; 267/141.1

(57) ABSTRACT

A hydraulic bearing has an inner part (1) with an elastomeric bearing body (2) connected to the inner part (1) by vulcanization and an outer sleeve (3) accommodating the bearing body (2). At least two damping agent chambers (4, 4′) are filled with a viscous damping agent and are connected to one another through a flow or throttle channel (44) and are sealed by at least two sealing lips (5, 5′) arranged in the bearing body (2). At least one volume (6) is arranged separated from the damping agent chambers (4, 4′) and from the channel connecting them and is formed between the two sealing lips (5, 5′). The volume (6) is filled with a curing liquid (7) possessing elastic properties after curing. A process for manufacturing the hydraulic bearing is described.

### CROSS REFERENCE TO RELATED APPLICATIONS

This application claims the benefit of priority under 35 U.S.C. § 119 of German Patent Application DE 10 2005 054 852.0 filed Nov. 15, 2005, the entire contents of which are incorporated herein by reference.

### FIELD OF THE INVENTION

The present invention pertains to a hydraulic bearing and to a process for manufacturing a hydraulic bearing.

### BACKGROUND OF THE INVENTION

Bearings designed as simple rubber bushings with an inner part, an outer sleeve or an outer tube and an elastomeric bearing body arranged between them are frequently used in the automobile industry and specifically above all in the area of the chassis. Hydraulic damping methods, which can mean an essential improvement in comfort, are known for supporting the damping action of the elastomeric bearing body. These hydraulic bearings have at least two damping agent chambers, which are formed in the bearing body and which are filled with a viscous damping agent and are connected to one another in a flow-conducting manner through at least one channel each. It must be ensured concerning the shape of the hydraulic bearings that the viscous damping agent cannot escape, i.e., that the bearing is sealed and also remains sealed for the necessary service life. The hydraulic bearings have seals for this.

A measure frequently encountered in practice in case of elastomeric bush bearings is, for example, to design the elastomeric bearing body, in the area of its axial ends, with an oversize compared to the outer sleeve accommodating the bearing. A so-called calibration takes place in the course of the mounting of the hydraulic bearing and when the outer tube is being pushed on by the outside dimensions of the outer tube being reduced at least in the area of its axial ends by means of devices suitable for this purpose. A pretension, which leads to sealing action, is generated hereby in the elastomeric sealing areas formed at the axial ends of the bearing body. A bearing designed in this manner is disclosed, for example, in DE 28 41 505 A1.

The latter solution has proved to be successful at least in respect to the sealing of the bearings against the escape of the viscous damping agent. However, it is also known for certain applications that hydraulic bearings can be designed such that vacuum is present against the ambient pressure in their damping agent chambers formed in the bearing body to accommodate the viscous damping agent. There is a risk in this case that even though the damping agent will not escape from the damping agent chambers, air will penetrate into the damping agent chambers and the function of the component will be compromised as a consequence of an increase in the pressure inside the chambers. This risk arises from the fact that the viscosity of the air is markedly lower than that of the damping agent present in the damping agent chambers, so that even though the sealing action achieved by means of a sealing lip formed at the bearing may be sufficient for the damping agent, it is not sufficient for sealing against the penetration of air. Air may thus penetrate into the damping agent chambers, especially as a consequence of temperature changes.

A similar problem also arises in case of the design according to EP 1 291 549 A1. This document describes a hydraulic bearing, which comprises a cylindrical inner part, an elastomeric bearing body surrounding the inner part and an outer sleeve accommodating the inner part with the bearing body, wherein two damping agent chambers, which are filled with a viscous damping agent and are connected to one another through a flow or throttle channel, are arranged in the bearing body. The damping agent chambers are sealed against the escape of the damping agent by sealing lips formed at the axial ends of the hydraulic bearing, and a volume, which is arranged separated from the damping agent chambers and the channel connecting same, is formed between the sealing lips, and this volume is filled with a viscous liquid.

It is necessary in this hydraulic bearing to use the same liquid in the volumes between the sealing lips and the damping agent chambers because a drawback of this prior-art embodiment is that air that has once penetrated into the sealing area can also enter the damping agent chambers via recesses at the axially inner sealing lip. However, this is to be avoided by all means, because the hydraulic bearing would thus become unfit for use.

### SUMMARY OF THE INVENTION

The object of the present invention is to provide a hydraulic bearing and a process for manufacturing a hydraulic bearing, which can be manufactured in a simple manner and at low cost and reliably guarantees sealing action of the finished hydraulic bearing both against the escape of damping agent from the bearing and against the penetration of air into the bearing.

The hydraulic bearing according to the present invention may be a hydraulic, elastomeric bush bearing (the basic concepts of the design being known). It comprises an inner part, an elastomeric bearing body, which surrounds the inner part and is connected to same by vulcanization, as well as an outer sleeve accommodating the aforementioned components, i.e., the inner part with the bearing body. To embody hydraulic damping, at least two damping agent chambers, which are filled with a viscous damping agent and are connected to one another through a throttle or flow channel, are arranged in the elastomeric bearing body. The damping agent chambers are sealed against the escape of the damping agent by sealing lips, which are present, for example, at the axial front sides of the hydraulic bearing. These sealing lips are preferably embodied by areas of the elastomeric bearing body that have an enlarged outside diameter compared to the inside diameter of the outer sleeve. When the outer sleeve is mounted or pushed onto the bearing body, a pretension is generated hereby in the elastomer in the areas with an oversize. Reliable sealing against the damping agent is formed as a result because of the viscosity of the damping agent. It shall be emphasized that the volume formed between the sealing lips is not connected to the damping agent chambers in a flow-conducting manner and it is thus a volume arranged separated from the damping agent chambers and the channel connecting these. It is provided according to the present invention that a curing liquid each, which possesses elastic properties after curing, be filled into the at least one volume between the sealing lips.

A substantially improved sealing action can thus be achieved compared to prior-art solutions, and mounting is very simple and therefore inexpensive. For example, a material similar to silicone may be used as a curing liquid.

Various possibilities, which also depend, last but not least, on the particular application, may be considered for the geometric design of the seals and the volumes accommodating the curing liquid. Thus, it is conceivable to form corresponding seals by channel grooves extending completely around at the two axial ends of the bearing. However, it is also possible to interrupt such a groove at points at which sealing action is not necessary, for example, in the area of the load-bearing support. The seals are designed as segmented seals in this case.

In hydraulic bearings that are designed as elastomeric bush bearings, at least one volume of a corresponding design is preferably present at each of the axial ends of the bearing.

A hydraulic bearing according to the present invention may have the peculiarity that a flow-conducting connection is present between at least two of its volumes. Corresponding to an embodiment of this idea, it is possible, moreover, that all volumes of the hydraulic bearing have a flow-conducting connection with one another.

An injection method may be used to fill the at least one volume between the sealing lips with the curing liquid, which does, however, still possess sufficiently elastic properties even after its curing. Corresponding to an embodiment of the present invention, at least one filling opening may be provided for this in the elastomeric bearing body and/or in the outer sleeve. As a consequence of the fact that the liquid cures, this filling opening becomes sealed without further steps being needed for this. Corresponding to a practical embodiment, ethylene glycol may be used as the viscous liquid in the damping agent chambers to achieve the damping action.

After the inner part with the elastomeric bearing body vulcanized to it as well as the outer sleeve have been prefabricated, the damping agent chambers are first filled with the damping agent. Corresponding to a first process according to the present invention for manufacturing a hydraulic bearing, which is presented here, the outer sleeve is pushed onto the hydraulic bearing for the subsequent filling of the at least one volume in order to make it possible to subsequently fill the volume or the volumes with the curing liquid through the respective filling opening.

Another process for manufacturing a hydraulic bearing is characterized in that the damping agent chambers are first filled with the damping agent and the outer sleeve is first pushed onto the hydraulic bearing only up to the axially inner sealing lip, i.e., the sealing lip facing the damping agent chamber for the subsequent filling of the volume with a curing liquid, which possesses elastic properties after curing, to push the outer sleeve completely over the elastomeric bearing body after the volume has been filled with the curing liquid, which possesses elastic properties after curing.

Unlike in the process described before, the at least one volume between the sealing lips may be filled now, for example, in a liquid bath in a very simple manner.

Cleaning of the volumes that may become necessary after the filling of the damping agent chambers does not need to be mentioned here separately.

An advantageous possibility of manufacturing a hydraulic bearing according to the present invention can also be seen, according to a variant of the process, in carrying out the filling of the damping agent chambers directly in a damping agent bath. The outer sleeve is logically also pushed onto the elastomeric bearing body in the damping agent liquid. The filling of the damping agent chambers can thus take place without inclusions of air under the liquid surface, which guarantees an end product of high quality.

The process according to the present invention is also applicable to a hydraulic bearing provided with volumes on both sides. The filling of the volumes may be carried out alternatingly or, for example, when filling through a filling opening, simultaneously.

Calibration, carried out after the mounting of the hydraulic bearing, i.e., the reduction of the outer circumference of the outer sleeve at least in some sections, has considerable advantages, especially in the process according to the present invention. The increase in pressure brought about in the sealing areas with the calibration develops in the corresponding volumes because of the curing liquid possessing elastic properties.

For example, an injection nozzle, which is passed through the filling opening and is removed after the filling, may be used to fill the at least one volume.

The present invention shall be explained in greater detail below on the basis of an exemplary embodiments. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is an axial sectional detail cut away view of a hydraulic bearing according to a first process step of a first process according to the present invention;

FIG. 2 is an axial sectional detail cut away view of a hydraulic bearing according to a second process step according to the present invention;

FIG. 3 is an axial sectional detail cut away view of a hydraulic bearing according to a third process step according to the present invention;

FIG. 4 is an axial sectional detail cut away view of a completely mounted hydraulic bearing according to the present invention;

FIG. 5 is an axial sectional detail cut away view of a hydraulic bearing corresponding to a second process according to the present invention;

FIG. 6 is a schematic side view showing the connection between damping agent chambers as well as the interconnection of end volumes of a hydraulic bearing according to the present invention; and

FIG. 7 is a schematic sectional view taken at line 7-7 of FIG. 6.

### DESCRIPTION OF THE PREFERRED EMBODIMENTS

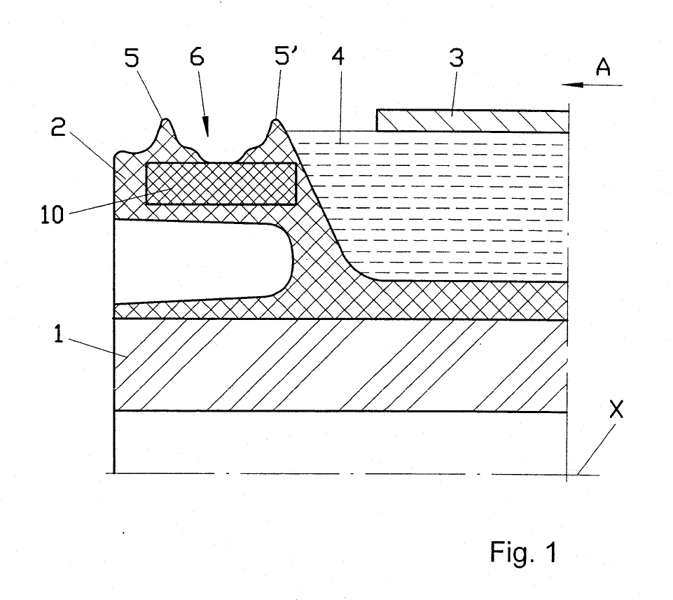

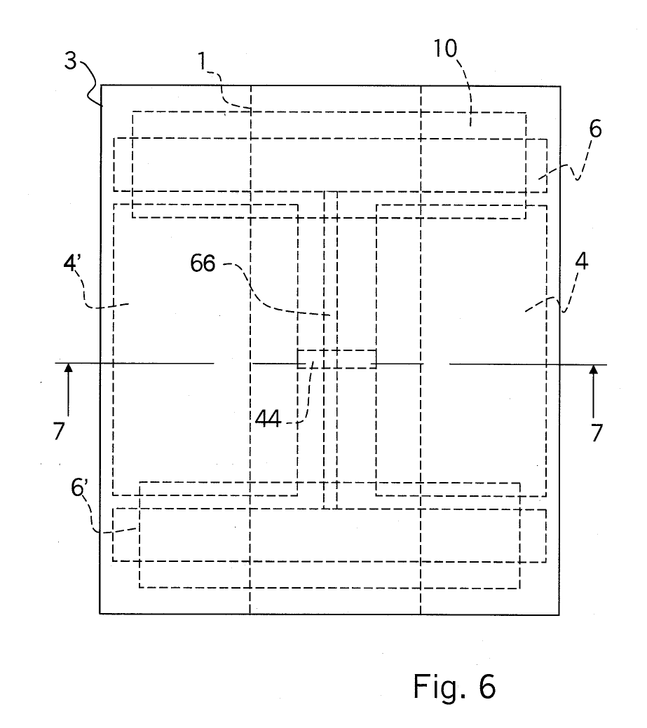

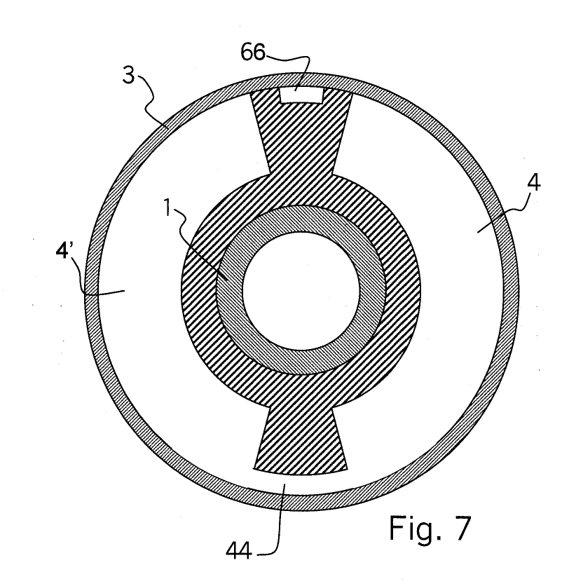

Referring to the drawings in particular, the hydraulic bearing illustrated in the figures comprises an inner part 1 made of metal or plastic, an elastomeric bearing body 2 connected to the inner part 1 by vulcanization and an outer sleeve 3, which accommodates the inner part 1 with the bearing body 2 and is tubular in this example. The outer sleeve 3 may likewise be manufactured from metal or plastic. Two damping agent chambers 4, 4′, which are filled with a viscous damping agent and which are connected to one another through an overflow channel or throttle channel 44 (FIGS. 6 and 7), are formed in the bearing body 2, only one axial half of the body, which is rotationally symmetrical to the central longitudinal axis X in the views of FIGS. 1-5. FIGS. 1-5 fail to show that the hydraulic bearing has the same design on both sides, i.e., it has a mirror symmetrical design at right angles to the central longitudinal axis X.

In the area of the front-side bearing end of the bearing, the elastomeric bearing body 2, which is designed as a rubber spring here, has a section with enlarged outside diameter. The outside diameter of the bearing body 2 is formed with an oversize compared to the inside diameter of the outer sleeve 3. Due to the outer sleeve 3 being pushed onto the bearing body 2 and a calibration, i.e., a reduction of the diameter of the outer sleeve 3, which may optionally be carried out subsequently, a pretension is generated in the sections of the bearing body 2 that are enlarged in terms of their diameter, especially at the axial ends of the bearing body, so that these areas act as a sealing lip 5 or 5′, respectively. The bearing is reliably sealed hereby against the escape of the viscous liquid present in the damping agent chambers 4, 4′. The volume 6 present between the sealing lips 5, 5′ has no flow-conducting connection with the damping agent chambers 4, 4′. This volume 6 is either a circular channel, not to be confused with the throttle channel 44, or a channel groove or individual chambers, which are formed in some sections along the circumference of the sealing lips 5, 5′, and their volume is usually, but not necessarily, smaller than the volume of the damping agent chambers 4, 4′ provided for generating the damping action of the bearing.

The inner part 1 and the outer sleeve 3 are first manufactured separately. The elastomeric bearing body 2 is subsequently connected to the inner part 1, which is possible by means of a vulcanization process in a manner known per se.

The components of the hydraulic bearing, which have thus been prefabricated, are subsequently introduced into a bath containing damping liquid, in which the outer sleeve 3 is pushed onto the elastomeric bearing body 2 under the liquid level.

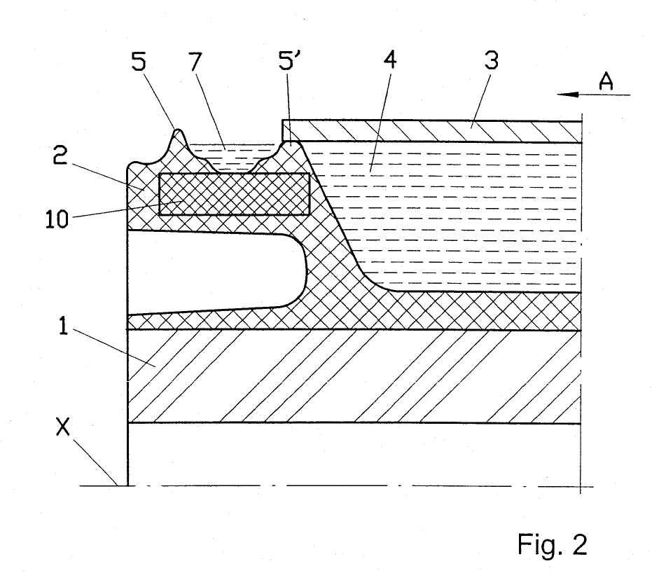

As is apparent from FIG. 2, the outer sleeve 3 is pushed on only up to the inner sealing lip 5′, i.e., the sealing lip facing the damping agent chamber 4. The assembly unit thus assembled is removed from the damping agent bath and at least the area of the volume 6 formed between the sealing lips 5 and 5′ is cleaned, which is possible with a rinsing agent suitable for this.

The processes being presented here differ from each other after this cleaning. Thus, according to a first process according to the present invention for manufacturing a hydraulic bearing, the entire hydraulic bearing may be immersed into a bath of the curing liquid 7 possessing elastic properties after curing, which liquid is enclosed in the volume 6 after the finishing of the hydraulic bearing. A simplified view of the volume 6 filled with the curing liquid 7, which possesses elastic properties after curing, is likewise shown in FIG. 2.

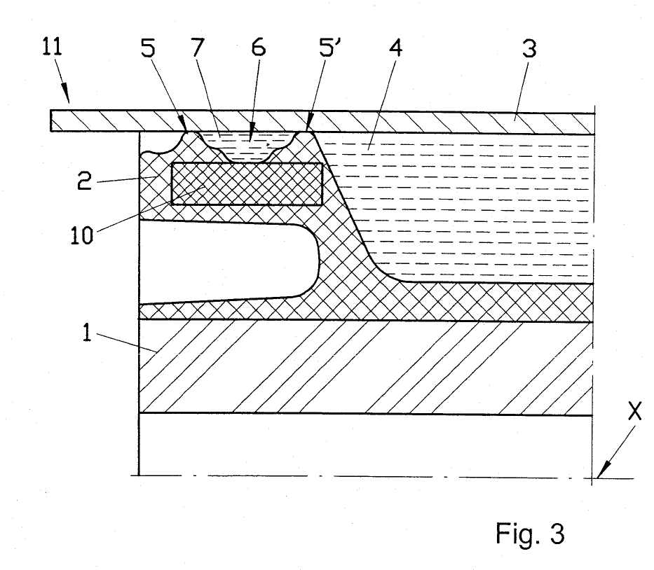

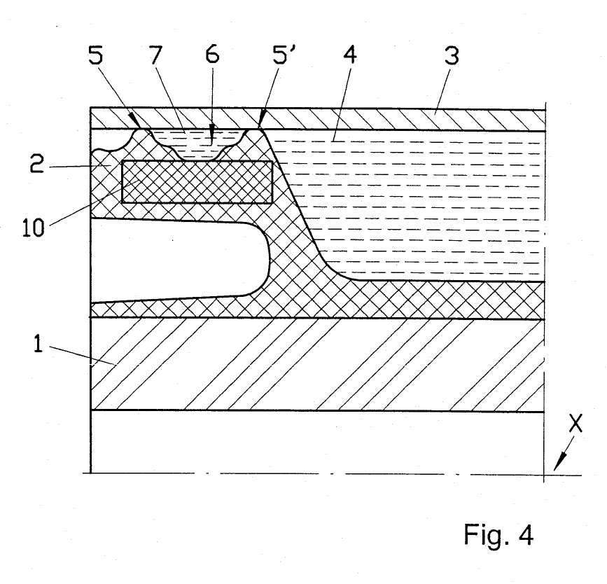

As is shown in FIG. 3, the outer sleeve 3 is pushed beyond the axial end of the hydraulic bearing in the next process step to the extent that a projection 11 of the outer sleeve 3 is formed, whose length corresponds to the distance of the sealing lips 5 and 5′ on the axially opposite side of the left-hand part of the hydraulic bearing shown in FIG. 3. Thus, the other end of the outer sleeve 3, which is not shown in FIG. 3, is sealingly in contact with the inner sealing lip 5′ present there, as this was already explained in the reverse direction in connection with the view in FIG. 2. The second volume 6′ can thus likewise be filled with the curing liquid 7 possessing elastic properties after curing.
The hydraulic bearing is finally finished by displacing the outer sleeve 3 relative to the central longitudinal axis X in the direction opposite the direction indicated by arrow A, whereby a flush closure of the front sides of the elastomeric bearing body 2 and of the outer sleeve 3 is achieved. The completely mounted hydraulic bearing is shown in a sectional view in FIG. 4.

A reinforcing insert, which is embedded in the elastomeric bearing body 2 and stabilizes the elastomer, is designated by 10 in the figures in a highly simplified form.

Regardless of the pressure in the damping agent chambers 4, 4′, a quantity of the curing liquid 7 possessing elastic properties after curing, by which a pressure, preferably an overpressure, is generated in relation to the ambient pressure in the course of the pushing on and the subsequent calibration of the outer sleeve 3, is introduced into the damping agent chambers 4, 4′. Since the sealing action of the sealing lips 5, 5′ against the viscous damping agent is sufficient in any case, the damping agent does not escape from the volumes 6, 6′ either to the outside or into the damping agent chambers 4, 4′. At the same time, the pressure prevailing in the volumes 6, 6′ reliably prevents air from penetrating from the environment into the bearing and into damping agent chambers 4, 4′ of the bearing, which may be under a vacuum.

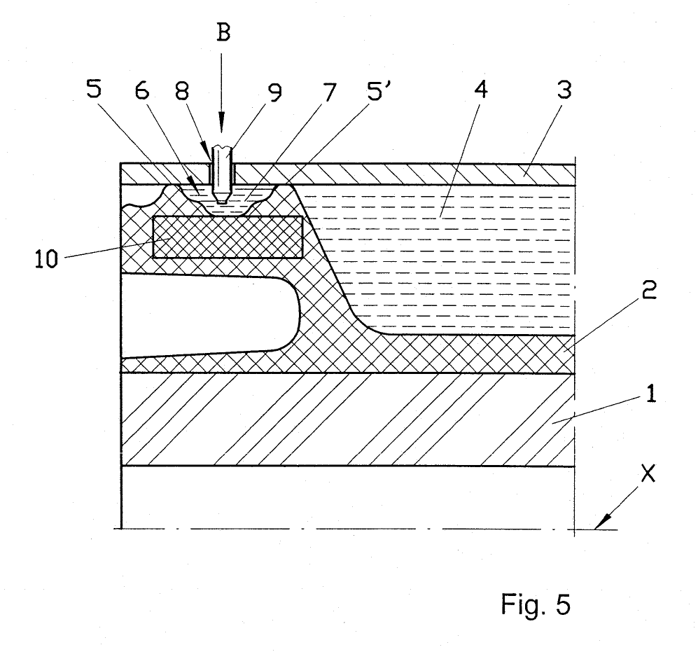

The hydraulic bearing illustrated in FIG. 5 has a design that is basically identical to the design described above. The same process steps as those described before are also observed in this hydraulic bearing until the filling of the damping agent chambers.

After filling the damping agent chambers, the volumes 6, 6′ are cleaned and the outer sleeve 3 is subsequently pushed completely on the elastomeric bearing body 2. The curing liquid 7 possessing elastic properties after curing can now be introduced into the volumes 6 and 6′ by means of an injection nozzle 9. A filling opening 8, through which the injection nozzle 9 is passed into the volume 6, is provided for this in the outer sleeve 3 (with the symmetrical structure allowing the same for volume 6′). After filling the volume 6 with the liquid 7 in the direction of arrow B in FIG. 5, the injection nozzle 9 is removed from the filling opening opposite the direction indicated by arrow B. This operation is concluded by a subsequent sealing of the volume 6 against the environment.

The schematic showing of FIG. 6 illustrates the basically symmetrical design of the sealing (additional) volumes 6 and 6′ at each end and the damping agent chambers 4, 4′, that are on each side. FIGS. 6 and 7 also illustrate the flow-conducting connection 66 between the two volumes 6 and 6′. The flow-conducting connection 66 may be provided between an outer part of the elastomeric bearing body 2 (provided in a groove or recess of the elastomeric bearing body 2) and the inner surface adjacent to the outer sleeve 3 and between the damping agent chambers 4, 4′, but opposite the throttle channel 44.

While specific embodiments of the invention have been shown and described in detail to illustrate the application of the principles of the invention, it will be understood that the invention may be embodied otherwise without departing from such principles.

What is claimed is:

1. A hydraulic bearing, comprising:
an inner part;
an elastomeric bearing body surrounding said inner part and connected to said inner part by vulcanization;
an outer sleeve accommodating said inner part with said elastomeric bearing body, said elastomeric bearing body cooperating with said outer sleeve to define two damping agent chambers, said two damping agent chambers being filled with a viscous damping agent, said two damping agent chambers being connected to one another through a flow or throttle channel;
sealing lips accommodated in said bearing body to define a volume, arranged between two said sealing lips, not connected to said damping agent chambers in a flow-conducting manner and arranged separated from said damping agent chambers and from said channel; and
a curing liquid filling said volume, said curing liquid possessing elastic properties after curing.

2. A hydraulic bearing in accordance with claim 1, wherein said volume is arranged circularly on a circumference of said bearing body at least in some sections in an area of said sealing lips.

3. A hydraulic bearing in accordance with claim 1, wherein said volume comprises a channel groove extending completely circularly on a circumference of said bearing body.

4. A hydraulic bearing in accordance with claim 1, further comprising:
another volume arranged between two further said sealing lips, said another volume not being connected to said damping agent chambers in a flow-conducting manner and being arranged separated from said damping agent chambers and from said channel; and
a curing liquid filling said another volume, said curing liquid possessing elastic properties after curing wherein said another volume is at one axial end of the bearing and said volume is at another axial end of the bearing.

5. A hydraulic bearing in accordance with claim 4, further comprising a flow-conducting connection between said volume and said another volume.

6. A hydraulic bearing in accordance with claim 1, wherein said elastomeric bearing body or said outer sleeve has at least one filling opening for introducing said curing liquid into said volume.

7. A process for manufacturing a hydraulic bearing, comprising:
providing an inner part;
connecting an elastomeric bearing body, surrounding said inner part, to said inner part by vulcanization;
providing an outer sleeve accommodating said inner part with said elastomeric bearing body, said elastomeric bearing body cooperating with said outer sleeve to define two damping agent chambers;
filling said two damping agent chambers with a viscous damping agent, said two damping agent chambers being connected to one another through a flow or throttle channel;
providing sealing lips accommodated in said elastomeric bearing body to define a volume, arranged between two said sealing lips, not connected to said damping agent chambers in a flow-conducting manner and arranged separated from said damping agent chambers and from said channel; and
subsequent to filling said damping agent chambers with the damping agent, pushing said outer sleeve onto said elastomeric bearing body for filling said volume in order to fill said volume with a curing liquid possessing elastic properties after curing through a filling opening.

8. A process for manufacturing a hydraulic bearing in accordance with claim 7, wherein the filling of said damping agent chambers is carried out in a damping agent bath.

9. A process in accordance with claim 7, further comprising:
providing another volume arranged between two further said sealing lips, said another volume not being connected to said damping agent chambers in a flow-conducting manner and being arranged separated from said damping agent chambers and from said channel; and
providing a curing liquid filling said another volume, said curing liquid possessing elastic properties after curing wherein said another volume is at one axial end of the bearing and said volume is at another axial end of the bearing.

10. A process in accordance with claim 9, further comprising:
filling said volume and said another volume with said curing liquid alternatingly.

11. A process in accordance with claim 9, further comprising:
filling said volume and said another volume with said curing liquid simultaneously.

12. A process in accordance with claim 7, wherein said outer sleeve is calibrated by reducing an outer circumference of said outer sleeve at least in some sections, after a mounting of the hydraulic bearing.

13. A process in accordance with claim 7, further comprising filling said volume with said curing liquid using an injection nozzle.

14. A process in accordance with claim 9, further comprising filling said volume and said another volume with said curing liquid using an injection nozzle.

15. A process for manufacturing a hydraulic bearing, comprising:
providing an inner part;
connecting an elastomeric bearing body, surrounding said inner part, to said inner part by vulcanization;
providing an outer sleeve accommodating said inner part with said bearing body, said elastomeric bearing body cooperating with said outer sleeve to define two damping agent chambers;
filling said two damping agent chambers with a viscous damping agent, said two damping agent chambers being connected to one another through a flow or throttle channel;
providing sealing lips accommodated in said bearing body to define a volume, arranged between two said sealing lips, not connected to said damping agent chambers in a flow-conducting manner and arranged separated from said damping agent chambers and from said channel;
subsequent to filling said damping agent chambers with the damping agent, pushing said outer sleeve onto the hydraulic bearing elastomeric bearing body only up to an axially inner sealing lip and subsequently filling said volume with a curing liquid, possessing elastic properties after curing, followed by pushing said outer sleeve completely onto said elastomeric bearing body after filling said volume with said curing liquid.

16. A process for manufacturing a hydraulic bearing in accordance with claim 15, wherein the filling of said damping agent chambers is carried out in a damping agent bath.

17. A process in accordance with claim 15, further comprising:
providing another volume arranged between two further said sealing lips, said another volume not being connected to said damping agent chambers in a flow-conducting manner and being arranged separated from said damping agent chambers and from said channel; and
providing a curing liquid filling said another volume, said curing liquid possessing elastic properties after curing wherein said another volume is at one axial end of the bearing and said volume is at another axial end of the bearing; and
filling said volume and said another volume with said curing liquid.

18. A process in accordance with claim 15, wherein said outer sleeve is calibrated by reducing an outer circumference of said outer sleeve at least in some sections, after a mounting of the hydraulic bearing.
